(19) United States
(12) Patent Application Publication
(10) Pub. No.: US 2009/0177796 A1
(43) Pub. Date: Jul. 9, 2009

(54) Method and Device for Diversion of Messages on a Mobile Terminal

(76) Inventors: Rainer Falk, Erding (DE); Dirk Kröselberg, München (DE); Domagoj Premec, Zagreb (HR); Maximilian Riegel, Nürnberg (DE)

Correspondence Address: STAAS & HALSEY LLP, SUITE 700, 1201 NEW YORK AVENUE, N.W., WASHINGTON, DC, 20005, US

(21) Appl. No.: 12/227,212

(22) PCT Filed: May 3, 2007
(86) PCT No.: PCT/EP2007/054283

§ 371 Date: Nov. 12, 2008

(30) Foreign Application Priority Data
May 12, 2006 (DE) 10 2006 022 369.1

(51) Int. Cl. G06F 15/173

(52) U.S. Cl. 709/238; 726/12

(57) ABSTRACT

A method and a device divert messages of a terminal, in particular, a mobile terminal from a first network provider connected to an access network by a gateway node of a second network provider. Network access identifiers are provided in the exchanged messages, made up of a character string for identifying the terminal and a character string for addressing a server of the network provider. The network access identifier is reformatted in the method such that the messages are not firstly transmitted to the server of the first network provider but rather to the server of the second network provider. After analysis of the data contained in the messages, the messages are then forwarded to the server of the first network provider after reverse formatting of the network access identifier.

### CROSS REFERENCE TO RELATED APPLICATIONS

This application is based on and hereby claims priority to German Application No. 10 2006 022 369.1 filed on May 12, 2006 and PCT Application No. PCT/EP2007/054283 filed on May 3, 2007, the contents of which are hereby incorporated by reference.

### BACKGROUND OF THE INVENTION

The invention relates to a method and device for diverting messages of a mobile terminal of a network provider, which is connected by way of a gateway node of another network provider to an access network.

In addition to the known WLAN technology (Wireless Local Area Network, standard IEEE 802.11) a very promising wireless access technology has been developed for wireless access for mobile terminals, which achieves even greater ranges of up to 30 km or more (line of sight) with high data throughputs of 75 MB/s. This wireless access technology is known as WiMax (Worldwide Interoperability for Microwave Access). With WLAN access in contrast, its limited transmit power means that only a range of up to around 100 m (direct line of sight) is achieved with a data transmission rate of up to 54 MB/s. With WLAN it is therefore possible simply to create hotspots, for example inside buildings. With WiMax access technology however an entire district can represent a metrospot with a radius of 800 to 1,000 m or an entire region can be covered with a distance of up to 30 km around a base station. With WiMax three frequency bands around 2.6 GHz, 3.5 GHz and 5.8 GHz are provided with widths of 100 to 200 MHx. WiMax supports mobile IP (in other words mobile terminals). Networks which provide internet access for mobile terminals, such as laptops, PDAs, etc., are subject to particular requirements relating to mobility management.

The WiMax Forum standardizes a network architecture for mobile networks based on the standard IEEE 802.16.

In many situations it is not possible for a mobile terminal or a gateway host (GH) to be connected directly to the base station BS of an access network ASN (Access Serving Network). If a mobile terminal is located for example in the underground car park of a first building, the antenna of a base station BS on the roof of another building cannot set up a communication connection to the mobile terminal, as the reinforced concrete of the first building attenuates or shields signals. In such instances a gateway node GMS is conventionally provided, by way of which the mobile terminals in the underground car park can set up a connection to the base station. The gateway or intermediate node (GMS) allows the terminals or gateway hosts (GH) to establish a connection to the access network ASN, which can be a WiMax access network for example. The connection between the terminals GH and the gateway node GMS can be realized in a wireless manner for example as a WLAN connection or in a wired manner for example as an Ethernet connection. The terminals or gateway hosts (GH) here have the WiMax keys to log onto the network. The mobile terminals GH use existing keys to authenticate themselves with the WiMax access network ASN by way of the gateway node GMS. This allows the terminals GH to be assigned the data traffic they produce and the charges to be billed to them accordingly.

In many instances however the terminal GH and the gateway node GMS have different network providers. FIG. 1 shows a schematic diagram of a network architecture according to the related art. A mobile terminal GH is connected by way of a WLAN interface to a gateway node GMS, the mobile terminal GH being operated by a first network provider NWP1 and the gateway node GMS being operated by another network provider NWP2. The gateway node GMS is connected by way of a wireless interface, for example by way of a WiMax interface, to an access network ASN, which includes a plurality of base stations BS. The base stations BS are linked to a gateway server ASN-GW of the access network ASN, which has an AAA server. The AAA server is either an AAA proxy server (AAA-P) or an AAA client server. As an AAA proxy the server of the access network ASN simply forwards received messages. As an AAA client the AAA server of the ASN gateway generates messages itself. The forwarded or generated messages, generated by the AAA server of the ASN gateway, are forwarded by way of intermediate networks that may be present to an AAA server of the home network of the mobile terminal GH. An AAA server implements authentication, authorization and accounting functions (AAA: Authentication, Authorization and Accounting). The messages are hereby exchanged according to the so-called radius or diameter data transmission protocol.

One disadvantage of the network architecture according to the related art illustrated in FIG. 1 is that the messages of the mobile terminal GH are transmitted directly by way of the access network ASN to the server of the home network of the mobile terminal AAA-GH, without an AAA server of the other network provider NWP2, in other words of the network provider for the gateway access node GMS, receiving these AAA messages. The network provider NWP2 of the access node GMS can therefore not account for the messages passing by way of its gateway node GMS. The network provider NWP2 of the access node cannot bill for services provided, which are used by the mobile terminal GH, and therefore also has no incentive to set up a corresponding gateway node GMS.

### SUMMARY

One potential object is therefore to create a method and device which, when a connection is set up from a terminal to an access network by way of a gateway access node set up by another network provider, allow the network provider of the gateway node to bill for the services made available.

The inventors propose a method for diverting messages of a terminal (GH) of a first network provider (NWP1), which is connected by way of a gateway node (GMS) of a second network provider (NWP2) to an access network (ASN), a network access identifier (NAI) contained in each instance in the messages of the terminal (GH) and possibly consisting of one character string (user) to identify the terminal and one character string (home-realm) to address a server (AAA-GH) of the first network provider (NWP1), being reformatted to divert the messages to a server (AAA-GMS) of the second network provider (NWP2).

The terminal GH is in particular a mobile terminal such as a PDA or a notebook.

The gateway node GMS can also be a mobile terminal or a fixed station.

In a preferred embodiment of the method the messages of the mobile terminal GH diverted to the server of the second network provider are forwarded from the server of the second network provider to the server of the first network provider.

The network access identifier (NAI) is preferably reformatted by the gateway node GMS of the second network provider.

In an alternative embodiment the network access identifier (NAI) is reformatted by a server of the access network (ASN).

In both instances the reformatting or so-called decoration does not take place in the terminal GH but in the network arrangement, so that particularly trusted routing or forwarding of the messages is achieved. One advantage here is that the components provided in the network have greater confidence in each other during the exchange of messages than in the case of messages received from a mobile terminal GH, as the opportunities for manipulation of messages exchanged in such a manner are fewer. Reformatting in the network means that it is also possible to achieve correct routing or forwarding of the AAA messages even with separate message paths for authentication and accounting or billing, in other words even if the AAA client for accounting is not located in the AAA signaling path for authentication.

In a preferred embodiment of the method the messages are formed by network logon and billing messages.

In a preferred embodiment of the method the network access identifier (NAI), contained in each instance in the messages of the terminal GH, has the following format:

NAI=user@home-realm,
where “user” is a character string to identify the mobile terminal and “home-realm” is a character string to address a server of the first network provider.

In a preferred embodiment of the method the network access identifier NAI is reformatted to become a modified network access identifier NAI′, the reformatted network access identifier having the following format:

NAI=home-realm!user@other-realm,
where “other realm” is a character string to address a server of the second network provider.

In a preferred embodiment of the method the server of the second network provider, on receipt of a message diverted to it, reverse formats the modified network access identifier NAI′ back to the original network access identifier NAI, to forward the message to the server of the first network provider.

In a preferred embodiment of the method the server of the second network provider evaluates data, which is contained in the message diverted to it, before forwarding the message to the server of the first network provider.

In a preferred embodiment of the method the data contained in the diverted message includes accounting data for billing for network access by way of the gateway node GMS of the second network provider, said accounting data being processed by the server of the second network provider.

In a particularly preferred embodiment of the method the gateway node GMS is formed by a WiMax gateway node.

In a preferred embodiment of the method messages are transmitted between the mobile terminal GH and the gateway node GMS by way of a wireless radio interface or by way of a wired interface.

In an embodiment of the method messages are transmitted between the gateway node GMS and the access network ASN by way of a wireless radio interface.

The gateway node GMS is preferably formed by a mobile node.

Alternatively the gateway node GMS is formed by an immobile node or a fixed station.

The inventors also propose a gateway node GMS of a network provider for mobile terminals GH, which are connected by way of an interface to the gateway node GMS for connection to an access network ASN, the gateway node GMS reformatting a network access identifier NAI, which is contained in a message received from a mobile terminal GH, in such a manner that the message of the mobile terminal GH is diverted to a server AAA-GMS of the gateway network provider.

In a preferred embodiment of the gateway node the gateway node GMS is a WiMax node, which is connected by way of a radio interface to a base station BS of the access network ASN.

The base station is preferably linked to a gateway processor ASN-GW of the access network ASN, which is connected to the server AAA-GMS of the gateway network provider and to the servers of further network providers by way of a network.

In a particularly preferred embodiment of the gateway node GMS the server of the gateway network provider forwards the message of a mobile terminal GH diverted to it to a server AAA-GH of the network provider of the mobile terminal GH after reformatting the network access identifier.

The inventors further propose a gateway server of an access network (ASN), which reformats a network access identifier (NAI), which is contained in a message originating from a terminal (GH) of a first network provider (NWP1), which is received from a gateway node (GMS) of a second network provider (NWP2) and transmitted to the gateway server (ASN-GH) of the access network (ASN), in such a manner that the message is transmitted to a server (AAA-GMS) of the network provider of the gateway (GMS) instead of to a server (AAA-GH) of the network provider of the terminal (GH).

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1: shows a network arrangement according to the related art;

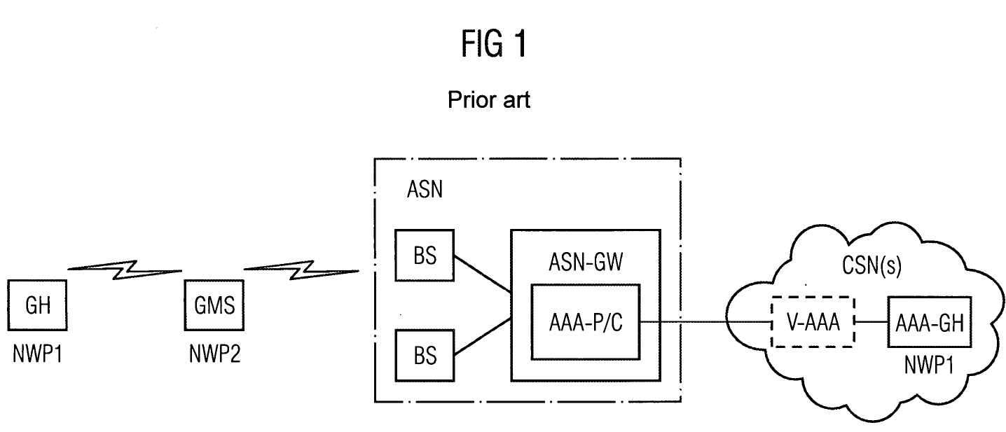

FIG. 2: shows a network arrangement to clarify the reformatting process deployed with the proposed method to reformat a network access identifier NAI;

FIG. 3: shows a table to clarify the reformatting process deployed with the proposed method to reformat a network access identifier;

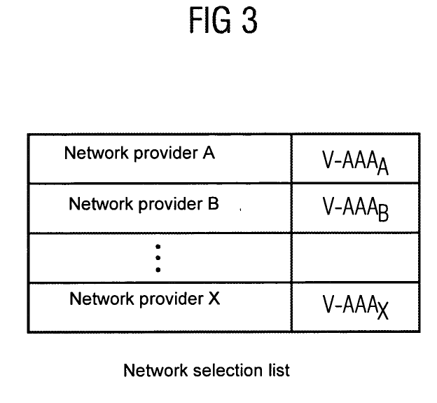

FIG. 4: shows a network arrangement to clarify the proposed method;

FIG. 5: shows a signal diagram to clarify a possible embodiment of the proposed method.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

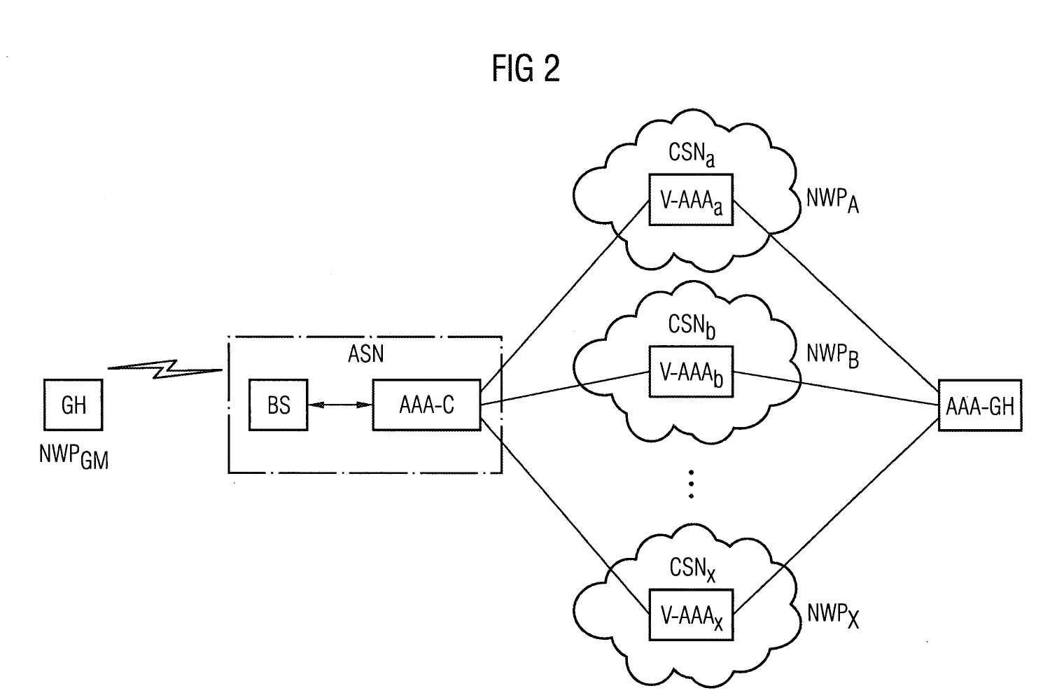

The network arrangement illustrated in FIG. 2 serves to clarify a reformatting process deployed in the method proposed by the inventors to reformat a network access identifier NAI, also referred to as NAI decoration. As shown in FIG. 2, a terminal GH, in particular a mobile terminal GH, is connected by way of a radio interface to a base station BS of an access network ASN. The base station BS is linked to an AAA server of a gateway of the access network ASN. The AAA client server generates AAA messages, which in each instance contain a network access identifier NAI. When logging onto a network a user makes their network access identifier NAI known to the network, so that the network can route the user's authentication data to the correct AAA server, in other words the user's home AAA server. The network access identifier NAI comprises two character strings, separated from one another by an @ character. The first character string “user” identifies the subscriber or user and the second character string “realm” identifies the AAA server of the subscriber's home network.

NAI=user@home-realm

The network access identifier NAI does not have to be identical to the email address of the user or identical to a user identity, which is deployed in an application layer. When the user logs onto the network, the AAA server of the access network stores the network access identifier NAI.

With the network arrangement illustrated in FIG. 2 the messages of the user can be transmitted from the access network ASN by way of different intermediate networks CSN (Connectivity Service Network) to the AAA server in the home network of the router. In the instance illustrated in FIG. 2 the intermediate networks CSN are operated by network providers NWP, which are different from the network operator NWP_{GH} of the terminal GH. So-called roaming agreements usually exist between the different network providers NWP, allowing the transmission of messages by way of networks of other network providers.

Present in the AAA server of the access network ASN is a network selection list for example, containing the addresses of the different AAA servers of different network providers, which are connected to the AAA server of the access network ASN and by way of which AAA messages can be forwarded. If the network provider of the terminal NWP_{GH} shown in the example illustrated in FIG. 2 has concluded a roaming agreement with the network provider X, messages originating from the terminal GH are forwarded from the AAA server of the access network ASN by way of the AM server V-AAAₓ to the AAA server AAA-GH of the home network of the mobile terminal GH. So that the server of the access network ASN recognizes this, reformatting or decoration of the network access identifier NAI contained in the messages takes place within the terminal GH.

The network access identifier NAI contained in the messages of the terminal has the following format before reformatting:

NAI=user@home-realm,
where “user” represents a character string to identify the terminal or subscriber and “home-realm” represents a character string to address the AAA-GH server of the network provider of the mobile terminal.

After reformatting by the terminal GH the network access identifier NAI′ has the following format:

NAI′=home-realm!user@other-realm,
where “other realm” is a character string to address the AAA server “V-AAAₓ” of the network provider NWPₓ, with which the network provider of the terminal GH has concluded a roaming agreement.

The authenticated terminal GH carries out the NAI decoration itself, to specify a selected visited network ASNₓ. Messages originating from the terminal GH with the reformatted network access identifier NAI′ are forwarded by way of the AAA server of the visited network CSNₓ to the home AAA server AAA-GH of the mobile terminal GH.

This reformatting mechanism used during network selection to reformat the network access identifier NAI is deployed with the method to bill the mobile terminal GH for charges for services of a gateway node GMS, which is operated by another network provider.

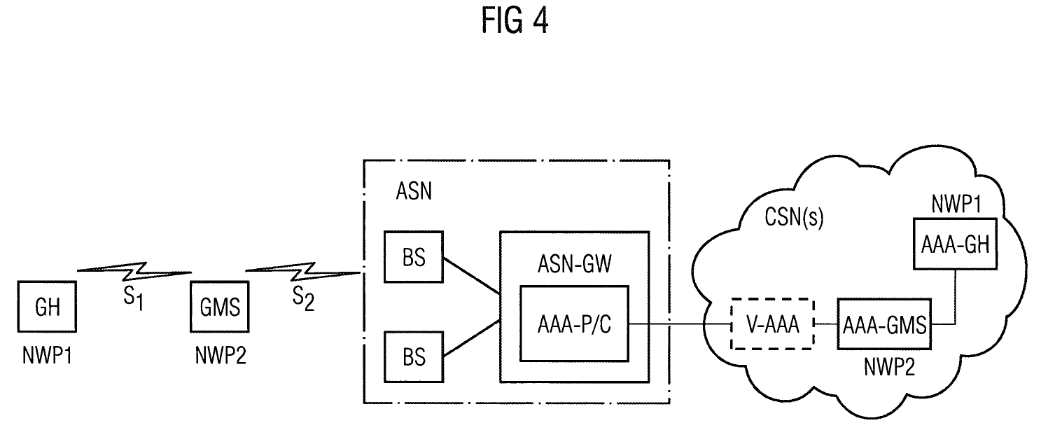

FIG. 4 shows a network arrangement to clarify the method. A terminal GH, which can be a mobile or immobile terminal, is assigned to a first network provider NWP1. The terminal or gateway host is connected by way of a first interface S1, for example by way of a WLAN interface according to IEEE 802.11, to an intermediate node GMS (Gateway-MS), which is operated by a second network provider NWP2 or has been set up by this latter. The gateway node GMS can be a fixed station or a mobile station MS, in particular a mobile WiMax station. The intermediate node or gateway node GMS is connected by way of a second interface S2, which can for example be a wireless WiMax interface according to IEEE 802.16, to an access network ASN (Access Serving Network). The access network ASN has a plurality of base stations BS, which allow a data transmission connection to the intermediate node GSM. The base stations BS of the access network ASN are connected to at least one gateway node ASN-Gateway of the access network ASN, which has an AAA server (AAA-P/C). The AAA server is either an AAA proxy server and/or an AAA client server. While an AAA proxy server (AAA-P) simply forwards received AAA messages, an AAA client server (AAA-C) is able to generate AAA messages itself. The gateway ASN-GW of the access network ASN is linked by way of optionally provided intermediate networks (V-AAA; Visited AAA server) to an AAA server of the second network provider NWP2.

With the method the messages of the terminal GH of the first network provider NWP1, which is connected by way of the gateway node GMS of the second network provider NWP2 to the access network ASN, are not routed directly to an AAA server of the home network of the mobile terminal GH but are routed first to the AAA server of the second network provider NWP2. To this end the network access identifier NAI, which is contained in a message of the terminal and possibly consists of one character string (user) to identify the terminal GH and one character string (home-realm) to address a server of the first network provider NWP1, is reformatted to divert the messages to the server AAA-GMS of the second network provider NWP2.

Reformatting preferably takes place according to the reformatting mechanism known from the network selection, in other words according to the NAI decoration mechanism.

In a first embodiment of the method reformatting of the network access identifier takes place in the gateway node GMS of the second network provider NWP2.

In an alternative embodiment reformatting of the network access identifier NAI is carried out by a server of the access network, in other words by an AAA client or AAA proxy server of the access network ASN. The AAA server can be located within a gateway of the access network ASN-GW for example. Reformatting of the network access identifier NAI causes the messages of the terminal GH directed originally to the AAA server GH of the home network to be diverted, so that they are now routed to the AAA server of the second network provider NWP2. There is as it were a switching of the destination address.

If the redecoration or reformatting of the network access identifier NAI is carried out by the gateway node GMS, this latter can reformat the network access identifier NAI (NAI=user@home-realm) to become a modified network access identifier NAI′ as follows:

NAI′=home-realm!user@other-realm

Here “other-realm” is a character string, which serves in a possible embodiment to address a server of the second network provider NWP2. However the character string can alternatively also use an administratively configured realm address or character string. The intermediate node GMS represents the AAA client for the authentication data exchanged in the context of the network logon of the terminal GH.

Redecoration or reformatting is carried out by an AAA client server of the access network ASN or an AAA client present in the gateway node GMS communicates with an AAA proxy server in the access network ASN. With this variant the AAA proxy server carries out the decoration or reformatting of the network access identifier NAI. The realm part of the network access identifier used by the gateway node GMS during network logon is used for this purpose. The AAA proxy server uses this realm directly or inputs it into the decorated host NAI. Alternatively the network access identifier NAI of the gateway node GMS is mapped on a realm using a mapping table and this mapped realm is input into the decorated or reformatted host network access identifier NAI.

The AAA client is located in the gateway of the access network (ASN-GW) for accounting or billing data of the terminal GH. In a first variant the AAA client creates the accounting data of the mobile terminal GH with the reformatted network access identifier NAI′. Alternatively the AAA proxy stores the reformatted NAI, which the gateway node GMS undertakes during the network logon of the mobile terminal GH, and the AAA client uses it for the accounting data for the mobile terminal GH.

Messages of the terminal GH diverted to the server AAA-GMS of the second network provider NWP are forwarded from the server AAA-GMS of the second network provider NWP2 to the server AAA-GH of the first network provider NWP1. The server AAA-GMS of the second network provider NWP2 evaluates data contained in diverted messages, before forwarding the message to the server AAA-GH of the first network provider NWP1. If the messages contain accounting data in particular for billing for network access of the terminal by way of the gateway node GMS, this data is processed by the server AAA-GMS of the second network provider NWP2, before the messages are forwarded.

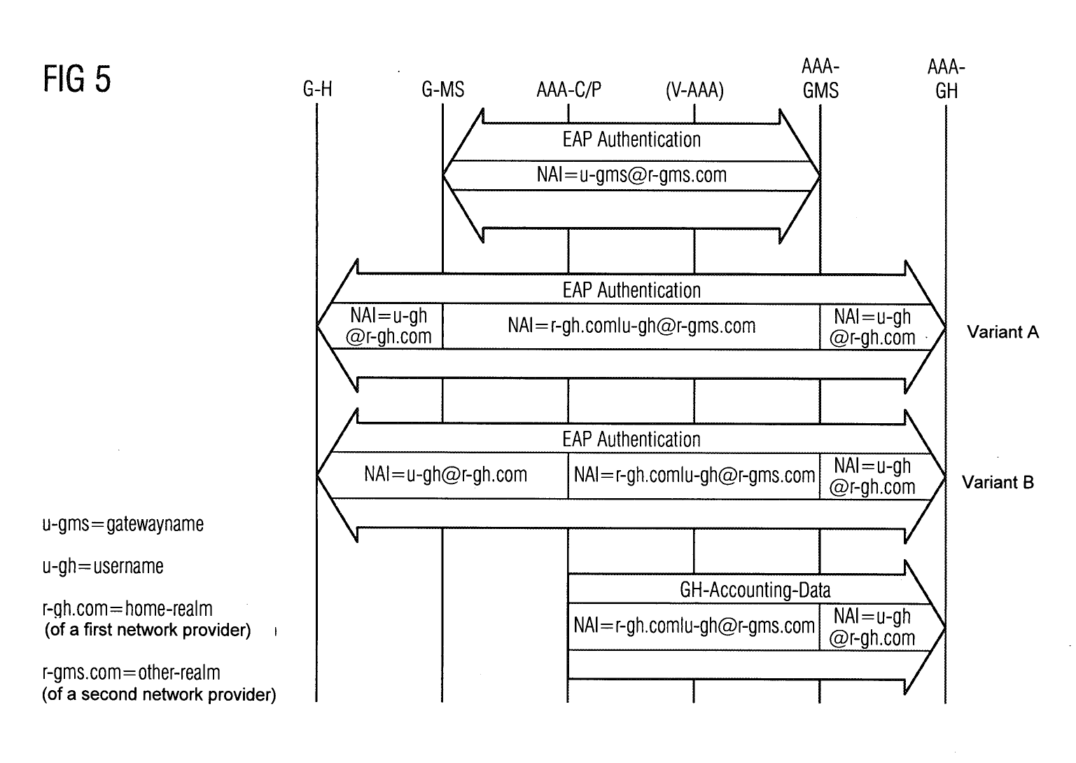

FIG. 5 shows a signal diagram to clarify the method. A network logon of the gateway node GMS with its network access identifier NAI=gatewayname@other-realm=u-gms@r-gms.com takes place first at the AAA server AAA-GMS of the gateway node.

This is followed by access authentication and/or network logon of the terminal GH.

With the variant A illustrated in FIG. 5 the network access identifier is reformatted by the gateway node GMS.

With the variant B illustrated in FIG. 5 the network access identifier NAI is reformatted or decorated by the AAA proxy server of the access network ASN.

The AAA messages are then diverted, as shown in FIG. 5, with the redecorated or reformatted network access identifier by way of the AAA server of the gateway node (AAA-GMS) and first evaluated there. Once the accounting data or billing data has been calculated by the AAA-GMS server of the gateway node GMS, the messages are forwarded to the AAA server of the home network, after the network access identifier NAI has been reverse formatted.

The method allows logon and accounting data of a terminal or host to be routed by way of the home AAA server of the gateway node and also to be processed there. This is important in particular so that the operator of the gateway node GMS can bill users for use of the gateway node by the terminal. The method has the advantage that there are no additional requirements for the terminal, in other words the reformatting of the network access identifier NAI is not carried out by the mobile terminal itself but either by the gateway node GMS or by an AAA server of an access network ASN. The circuit-related outlay for the mobile terminal GH is therefore not increased by the method.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-16. (canceled)

17. A method for diverting messages of a terminal of a first network provider, which is connected by way of a gateway node of a second network provider to an access network, comprising:
reformatting an original network access identifier (NAI) contained in each message of the terminal to be diverted, the network access identifier having one character string to identify the terminal and one character string to address a server of the first network provider, the network access identifier being reformatted to produce a modified network access identifier and to divert the message to a server of the second network provider; and
reverse formatting the modified network access identifier at the server of the second network provider, upon receipt of the message at the server of the second network access provider, the modified network access identifier being reformatted back to the original network access identifier, wherein
the original network access identifier has the following format:
NAI=user@home-realm,
where “user” is the character string to identify the terminal, and “home-realm” is the character string to address the server of the first network provider, and
the modified network access identifier has the following format:
NAI=home-realm!user@other-realm,
where “other realm” is a character string to address the server of the second network provider.

18. The method as claimed in claim 17, further comprising:
forwarding the messages of the terminal diverted to the server of the second network provider, the messages being forwarded from the server of the second network provider to the server of the first network provider.

19. The method as claimed in claim 17, wherein
the network access identifier is reformatted by a gateway node of the second network provider.

20. The method as claimed in claim 17, wherein
the network access identifier is reformatted by a server of the access network.

21. The method as claimed in claim 17, wherein
network logon and accounting messages are diverted.

22. The method as claimed in claim 18, wherein
the server of the second network provider evaluates data contained in the message that was diverted before forwarding the message to the server of the first network provider.

23. The method as claimed in claim 6, wherein
the data contained in the message that was diverted includes accounting data to bill for network access via the gateway node of the second network provider, and
the accounting data is processed by the server of the second network provider.

24. The method as claimed in claim 17, wherein
the gateway node is a WiMax gateway node.

25. The method as claimed in claim 17, wherein
messages are transmitted between the terminal and the gateway node by way of a wireless radio interface.

26. The method as claimed in claim 17, wherein
messages are transmitted between the terminal and the gateway node by way of a wired interface.

27. The method as claimed in claim 17, wherein
messages are transmitted between the gateway node and the access network by way of a wireless radio interface.

28. The method as claimed in claim 17, wherein
the gateway node is a mobile node .

29. The method as claimed in claim 17, wherein
the gateway node is an immobile node.

30. The method as claimed in claim 17, wherein
only network logon and accounting messages are diverted.

31. A gateway node of a second network provider, comprising:
a first interface to connect the gateway node to mobile terminals of a first network provider and to receive messages from the mobile terminals;
a second interface to connect that gateway node to an access network; and
a formatting unit to reformat an original network access identifier, which is contained in a message received from a terminal, to produce a modified network access identifier so that the message from the terminal is diverted to a server of the second network provider, wherein
the modified network access identifier is reverse formatted at the server of the second network provider, upon receipt of the message at the server of the second network access provider, the modified network access identifier being reformatted back to the original network access identifier,
the original network access identifier has the following format:
NAI=user@home-realm,
where “user” is the character string to identify the terminal, and “home-realm” is the character string to address the server of the first network provider, and
the modified network access identifier has the following format:
NAI=home-realm!user@other-realm,
where “other realm” is a character string to address the server of the second network provider.

32. The gateway node as claimed in claim 31, wherein
the gateway node is a WiMax node,
the second interface connects the gateway node to a base station of the access network, and
the second interface is a radio interface.

33. The gateway node as claimed in claim 32, wherein
the base station is linked to a gateway processor of the access network,
the base station is connected to the server of the second network provider and to the servers of other network providers by way of a network.

34. The gateway node as claimed in claim 33, wherein
the server of the second network provider forwards the message to a server of the first network provider after reverse formatting the network access identifier.

35. A gateway server of an access network, comprising:
a first interface to connect the gateway server to a gateway node of a second network provider so that the gateway server can receive a message originating from a terminal of a first network provider;
a second interface to connect the gateway server to a server of the second network provider and a server of the first network provider; and
a formatting unit to reformat an original network access identifier, which is contained in the message received from the terminal via the gateway node, to produce a modified network access identifier so that the message is transmitted to the server of the second network provider instead of to the server of the first network provider, wherein
the modified network access identifier is reverse formatted at the server of the second network provider, upon receipt of the message at the server of the second network access provider, the modified network access identifier being reformatted back to the original network access identifier,
the original network access identifier has the following format:
NAI=user@home-realm,
where “user” is the character string to identify the terminal, and “home-realm” is the character string to address the server of the first network provider, and
the modified network access identifier has the following format:
NAI=home-realm!user@other-realm,
where “other realm” is a character string to address the server of the second network provider.
